(19) United States
(12) Patent Application Publication
(10) Pub. No.: US 2025/0269849 A1
(43) Pub. Date: Aug. 28, 2025

(54) DRIVER ASSISTANCE DEVICE

(71) Applicant: TOYOTA JIDOSHA KABUSHIKI KAISHA, Toyota-shi (JP)

(72) Inventor: Daisuke FUKUTOMI, Toyota-shi (JP)

(73) Assignee: TOYOTA JIDOSHA KABUSHIKI KAISHA, Toyota-shi (JP)

(21) Appl. No.: 18/966,163

(22) Filed: Dec. 3, 2024

(30) Foreign Application Priority Data
Feb. 26, 2024 (JP) 2024-026228

(51) Int. Cl. B60W 30/12

(52) U.S. Cl. CPC B60W 30/12; B60W 2540/20; B60W 2552/53

(57) ABSTRACT

A driver assistance device includes an on-vehicle sensor including a sensor acquiring a position and an attitude of an own vehicle traveling in a lane and a sensor acquiring a vehicle speed of the own vehicle, and a processor executing lane keeping processing for controlling the own vehicle to travel along the lane. The processor restricts execution of the lane keeping processing triggered by a turn signal lamp of the own vehicle starting to operate under a condition that the own vehicle travels in a first lane, and then stops the operation of the turn signal lamp and releases the restriction on the execution of the lane keeping processing when lane change to a second lane adjacent to the first lane is determined to be completed and a predetermined release condition for determining that the own vehicle can be controlled to travel along the second lane is satisfied.

### CROSS-REFERENCE TO RELATED APPLICATION

This application claims priority to Japanese Patent Application No. 2024-026228 filed on Feb. 26, 2024, incorporated herein by reference in its entirety.

### BACKGROUND

### 1. Technical Field

The disclosure relates a driver assistance device for controlling a steering device of an own vehicle such that the own vehicle travels along a lane.

### 2. Description of Related Art

There has been proposed a driver assistance device that controls a steering device of an own vehicle such that the own vehicle travels along a lane (for example, see Japanese Unexamined Patent Application Publication No. 2022-77931 (JP 2022-77931 A) described below). The driver assistance device of JP 2022-77931 A (hereinafter referred to as a “conventional device”) analyzes an image (foreground image) obtained by imaging the foreground of the own vehicle, and controls the steering device of the own vehicle such that the own vehicle is positioned in the neighborhood of a center portion in a width direction of a lane (travel lane) (lane keeping function). The conventional device disables the lane keeping function in a period of time during which a driver is performing a driving operation (lane change) of shifting the own vehicle from a first lane in which the own vehicle is currently positioned to a second lane adjacent to the first lane. Specifically, the conventional device disables the lane keeping function when it is detected that a turn signal lamp of the own vehicle has started to operate (blink). After disabling the lane keeping function, the conventional device enables the lane keeping function when it determines, based on a foreground image, that a predetermined condition regarding the positional relation between the own vehicle and a lane marker (the boundary line between the first lane and the second lane) is satisfied (when it is determined that the own vehicle has crossed the lane marker).

### SUMMARY

Generally, when the steering device is automatically controlled by the lane keeping function, an upper limit value of the acceleration in the width direction (lateral acceleration) of the own vehicle (an upper limit value of a steering angle) is restricted in order to restrain occupants from feeling discomfort. Here, for example, in a case where the entry angle of the own vehicle into a second lane is relatively large during lane change from a first lane to the second lane, even when automatic steering is performed by the lane keeping function, there is a risk that the own vehicle departs from an edge portion of the second lane (the edge portion on the opposite side to the first lane) in the process of correcting the position and the attitude of the own vehicle for the second lane such that the own vehicle travels along the second lane because the upper limit value of the lateral acceleration (steering angle) of the own vehicle is restricted (because the turn radius of the own vehicle cannot be made too small). Furthermore, the conventional device enables the lane keeping function when a predetermined condition regarding the positional relation between the lane marker and the own vehicle is satisfied, but it is difficult for the driver to recognize the timing when the lane keeping function is enabled.

One of objects of the present disclosure is to provide a driver assistance device that can disable a lane keeping function at a timing when a driving operation for lane change is started, and then re-enable the function at an appropriate timing.

In order to solve the foregoing problem, a driver assistance device (1) according to the present disclosure includes:
an on-vehicle sensor (20) including sensors (21, 22, 23) that acquire a position and an attitude of an own vehicle with respect to a lane in which the own vehicle is traveling, and a sensor (24) that acquires a vehicle speed of the own vehicle, and
a processor (10) configured to execute lane keeping processing for controlling the own vehicle such that the own vehicle travels along the lane.
The processor restricts execution of the lane keeping processing with start of an operation of a turn signal lamp of the own vehicle as a trigger under a condition that the own vehicle is traveling in a first lane (L1), and then stop the operation of the turn signal lamp and release the restriction on the execution of the lane keeping processing when it is determined that lane change to a second lane (L2R, L2L) adjacent to the first lane has been completed and a predetermined release condition for determining that the own vehicle is enabled to be controlled to travel along the second lane is satisfied.

As in the above conventional device, when the lane keeping processing is resumed at the time point when the lane change from the first lane to the second lane has been completed, the own vehicle may depart from the second lane within a short period of time after the resumption of the lane keeping processing in spite of the resumption of the lane keeping processing. When the processor of the driver assistance device according to the present disclosure determines that the lane change from the first lane to the second lane has been completed, the processor resumes the lane keeping processing when a condition for determining that the own vehicle can be controlled to travel along the second lane (release condition) is satisfied. This makes it possible to restrain the own vehicle from departing from the second lane within a short period of time after the resumption of the lane keeping process in spite of the resumption of the lane keeping processing on the second lane. In other words, according to the present disclosure, the lane keeping processing is resumed at an appropriate timing after the lane change has been completed. Furthermore, the operation of the turn signal lamp is automatically stopped (turned off) when the release condition is satisfied. This allows the driver to recognize that the lane keeping processing has been resumed. In other words, the driver can recognize that the driving operation (steering) can be entrusted to the driver assistance device to a certain extent.

In a driver assistance device according to one aspect of the present disclosure, the processor determines, based on information acquired from the on-vehicle sensor, that lane change from the first lane to the second lane has been completed when it is detected that all wheels of the own vehicle have entered the second lane.

According to the foregoing, the lane keeping processing (driver assistance) is restrained from being started in a state where the own vehicle is straddling a lane marker through which the first lane and the second lane are partitioned from each other.

In a driver assistance device according to another aspect of the present disclosure, the processor assumes that the lane keeping processing is resumed from a current time point when determining that the lane change has been completed, calculates a predicted trajectory (TR) which is an area through which the own vehicle is predicted to have passed until a predetermined condition regarding the position and the attitude of the own vehicle with respect to the second lane is satisfied by execution of the lane keeping processing, and determines that the release condition is satisfied when the predicted trajectory falls within the second lane.

According to the foregoing, when the release condition is satisfied, the own vehicle is caused to travel along the predicted trajectory, thereby restraining the own vehicle from departing from the second lane.

In a driver assistance device according to another aspect of the present disclosure, the processor stops an operation of the turn signal lamp when a cancel condition for determining that it is difficult to perform the lane keeping processing on the second lane is satisfied in a period of time before it is determined that lane change from the first lane to the second lane has been completed after detecting that the turn signal lamp starts to operate during traveling of the own vehicle in the first lane.

According to the foregoing, when it can be predicted before the lane change has been completed that it will be difficult to perform the lane keeping processing on the second lane, the driver is proposed (promoted) to interrupt the lane change.

In a driver assistance device according to another aspect of the present disclosure, the processor determines that the cancel condition is satisfied when a width of the second lane is equal to or less than a threshold value or when an obstacle is present in the second lane.

According to the foregoing, the driver can recognize that the width of the second lane is small or that an obstacle is present in the second lane.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a driver assistance device according to an embodiment of the present disclosure;

FIG. 2 is a plan view showing the attitude of an own vehicle for a lane;

FIG. 3 is a plan view showing an example in which a predicted trajectory falls within a second lane;

FIG. 4 is a plan view showing an example in which the predicted trajectory deviates from the second lane; and

FIG. 5 is a flowchart of a program.

### DETAILED DESCRIPTION OF EMBODIMENTS

### Outline

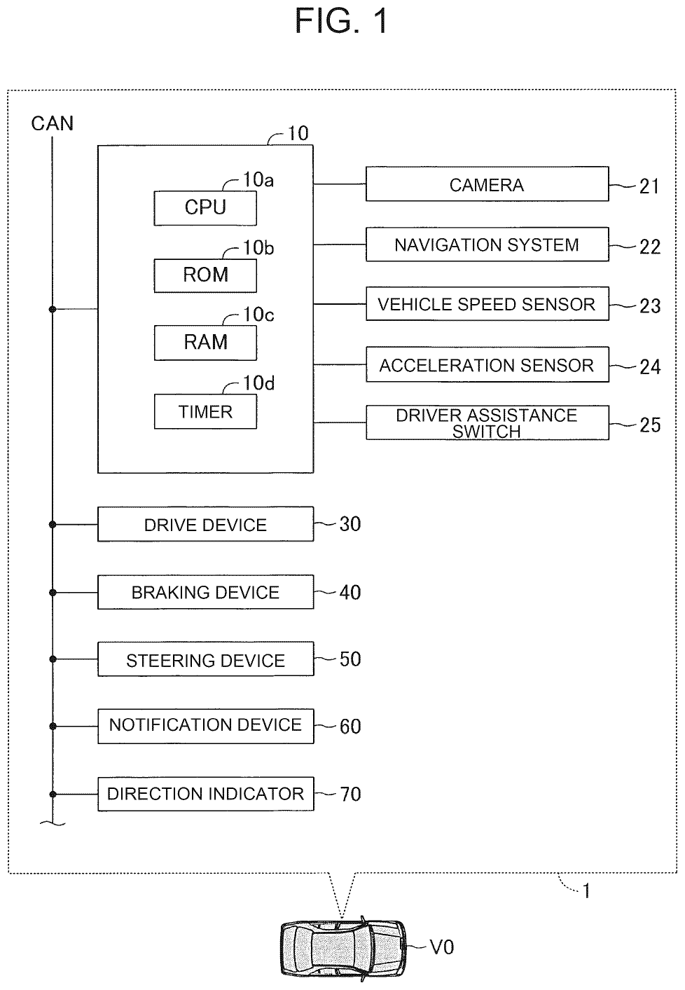

As shown in FIG. 1, a driver assistance device 1 (lane keeping device) according to an embodiment of the present disclosure is applied to a vehicle VO having an automatic driving function (hereinafter referred to as “own vehicle”). The driver assistance device 1 has a lane tracing assist (LTA) function that performs lane keeping control for controlling the own vehicle such that the own vehicle travels along a lane in which the own vehicle is traveling in a state where the automatic driving function is disabled (in a state where a driver is performing a driving operation).

### Specific Configuration

The driver assistance device 1 includes an ECU 10, an on-vehicle sensor 20, a drive device 30, a braking device 40, a steering device 50, a notification device 60, and a direction indicator 70.

The ECU 10 includes a microcomputer equipped with CPU 10a, ROM 10b (flash ROM), RAM 10c, a timer 10d, etc. The ECU 10 is connected to other ECUs equipped in the own vehicle via a controller area network (CAN).

The ECU 10 includes a microcomputer equipped with CPU 10a, ROM 10b, RAM 10c, a timer 10d, etc. The ECU 10 is connected to other ECUs via a controller area network (CAN).

The on-vehicle sensor 20 includes a camera 21, a millimeter wave radar 22, a navigation system 23, a vehicle speed sensor 24, an acceleration sensor 25, and a driver assistance switch 26.

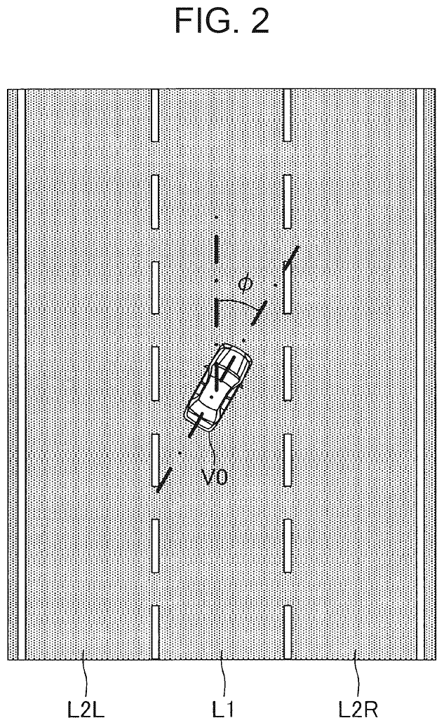

The camera 21 includes an imaging device and an image analysis device. The imaging device includes, for example, a CCD. The imaging device is installed at a front portion of the own vehicle. The imaging device images a predetermined area in front of the own vehicle at a predetermined frame rate to obtain a foreground image PIC. The image analysis device analyzes the foreground image PIC obtained from the imaging device to recognize objects in front of the own vehicle. For example, the image analysis device recognizes a preceding vehicle and lane marks (lane markers that partition lanes (travel lanes), etc. The image analysis device calculates the position of the own vehicle in a lane L1 in which the own vehicle travels (the position of the own vehicle in the width direction of the lane L1) and the attitude of the own vehicle in the lane L1 (the angle φ between a front-rear direction of the own vehicle and an extension direction of the lane L1 (for a curved road, the tangent at a current place) in plan view (FIG. 2), based on the positions (coordinates), extension directions, etc. of the lane marks in the foreground image PIC. The image analysis device provides the calculation results (position information and attitude information) to the ECU 10.

The millimeter wave radar 22 includes a transceiver and a signal processor. The transceiver radiates radio waves in a millimeter wave band (hereinafter referred to as “millimeter waves”) to a surrounding area of the own vehicle (forward of the own vehicle) and receives millimeter waves (reflected waves) reflected by a three-dimensional object located in the area. The signal processor acquires various information regarding each reflection point of the millimeter waves based on physical quantities such as a period of time from a time when the transceiver radiates the millimeter waves to a time when it receives the reflected waves, an attenuation level of the reflected waves, and the difference between the frequency of the radiated millimeter waves and the frequency of the received reflected waves, etc. For example, the signal processor calculates the position of each reflection point (relative position (direction and distance) to the transceiver). The signal processor also calculates the speed (relative speed) of each reflection point with respect to the own vehicle. Then, the calculation result (data representing the distribution of the reflection points (the position and relative speed of each reflection point with respect to the own vehicle) is provided to the ECU 10.

The navigation system 23 acquires position information indicating the current place (latitude and longitude) of the own vehicle based on a plurality of GPS signals. Furthermore, the navigation system 23 stores map information representing a map. The navigation system 23 acquires, based on the position information and the map information, information regarding a road including a lane in which the own vehicle is traveling (the number of lanes constituting the road, the degree of a curve), etc., and provides the information to the ECU 10.

The vehicle speed sensor 24 includes a rotation speed measurement circuit and a vehicle speed calculation device. The rotation speed measurement circuit includes a pulse generation circuit that outputs a pulse (electrical signal) every time the wheels of the own vehicle rotate by a predetermined angle, and a counter circuit that counts the number of the pulses. The vehicle speed calculation device acquires an output value (number of pulses) of the counter circuit at a predetermined cycle (every time a unit time has elapsed), and resets the count value to “0”. In this way, the vehicle speed calculation device acquires the number of rotations N of the wheels per unit time. The vehicle speed calculation device acquires the vehicle speed sp0 (absolute value) of the own vehicle by multiplying the number of rotations N by a coefficient k. Then, the vehicle speed calculation device provides the acquired vehicle speed sp0 to the ECU 10.

The acceleration sensor 25 includes a piezoelectric element. When the own vehicle accelerates (or decelerates) in a front-rear direction and/or in a width direction, the piezoelectric clement deforms in the front-rear direction (longitudinal direction) of the own vehicle and/or in the width direction (lateral direction) of the own vehicle, and the output voltage of the piezoelectric element changes according to the deformation. The acceleration sensor 25 acquires the accelerations in the longitudinal direction and lateral direction of the own vehicle based on the output voltage of the piezoelectric element. Then, the acceleration sensor 25 provides these accelerations to the ECU 10.

The driver assistance switch 26 includes a push button type normally open switch (ACC switch and LTA switch) that is used to request the driver assistance device 1 to execute driver assistance (ACC processing and LTA processing) described later. The ACC switch and the LTA switch are configured such that the ON/OFF states thereof are alternately switched to each other every time they are pressed. Furthermore, the ACC switch and the LTA switch can be forcibly transitioned to the OFF state by a command from another ECU.

The drive device 30 applies a driving force to the drive wheels. The drive device 30 includes an engine ECU, an internal combustion engine, a transmission, a driving force transmission mechanism for transmitting the driving force to the wheels, and the like. The engine ECU obtains a target value of the driving force from another ECU (ECU 10). The engine ECU controls a throttle valve of the internal combustion engine such that the driving force applied to the drive wheels coincides with the target value.

Note that when a vehicle to which the driver assistance device 1 is applied is a hybrid vehicle (HEV), the engine ECU can adjust the driving force of the vehicle to be generated by either or both of “an internal combustion engine and an electric motor” as a vehicle driving source. Furthermore, when a vehicle to which the driver assistance device 1 is applied is an electric vehicle (BEV), an electric motor ECU for adjusting the driving force of the vehicle to be generated by the “electric motor” as the vehicle driving source may be used instead of the engine ECU.

The braking device 40 applies a braking force to the wheel (brake disc). The braking device 40 includes a brake ECU, a brake caliper, and the like. The brake caliper includes an actuator for pressing a brake pad against the brake disc. The brake ECU obtains a target value of the braking force from another ECU. The brake ECU controls the actuator of the brake caliper such that the braking force applied to the wheel coincides with the target value.

The steering device 50 adjusts the steering angle of the steering wheel (left front wheel and right front wheel). The steering device 50 includes a steering ECU and a steering mechanism. The steering device 50 further includes an actuator (e.g., an electric motor) for driving the steering mechanism to change the steering angle, and a steering angle sensor for acquiring the steering angle (actual steering angle) of the steering wheel. The ECU 10 determines a target value θt of the steering angle θ (actual steering angle) of the steering wheel based on various information acquired from the on-vehicle sensor 20. For example, the ECU 10 determines the target value θt such that the own vehicle travels along the lane. The steering ECU acquires the target value θt from the ECU 10, and controls the actuator such that the actual steering angle output from the steering angle sensor coincides with the target value θt.

The notification device 60 includes an image display device and an audio device. The image display device is disposed, for example, on an instrument panel (for example, in the neighborhood of a speedometer). The image display device displays an image in accordance with a command acquired from the ECU 10. The audio device reproduces a sound in accordance with the command acquired from the ECU 10.

The direction indicator 70 includes an operating lever, a lever sensor, turn signal lamps, and a drive circuit (turn signal ECU). The lever sensor includes a first switch and a second switch whose ON/OFF states change depending on the position of the operating lever. When the operating lever is located at a neutral position, the first switch and the second switch are in the OFF state. When the operating lever is located at a first position (right turn indication position), the first switch is in the ON state, and the second switch is in the OFF state. When the operating lever is at a second position (left turn indication position), the first switch is in the OFF state, and the second switch is in the ON state. When the first switch is in the ON state, the drive circuit causes the right turn signal lamp to blink, and when the second switch is in the ON state, the drive circuit causes the left turn signal lamp to blink. Furthermore, the ECU 10 can obtain the ON/OFF states of the first switch and the second switch from the drive circuit. The ECU 10 can detect the operating states of the turn signal lamps of the own vehicle based on the ON/OFF states of the first switch and the second switch. The direction indicator 70 also has a function of forcibly returning the operating lever to the neutral position in accordance with a command from the ECU 10 (a device for forcibly turning off the turn signal lamps).

### Operation

When the ACC switch is in the ON state, the ECU 10 determines whether there is a preceding vehicle V1 as described below, and executes ACC processing for controlling the drive device 30 and braking device 40 of the own vehicle (hereinafter referred to as “drive device, etc.”) based on the determination result. The ACC processing includes constant-speed traveling processing and inter-vehicle distance keeping processing.

### Constant-speed Traveling Processing

The ECU 10 determines whether there is a preceding vehicle V1, based on information acquired from the on-vehicle sensor 20 (the camera 21 and the millimeter wave radar 22). When there is no preceding vehicle V1, the ECU 10 controls the drive device, etc. such that the vehicle speed sp0 of the own vehicle coincides with a predetermined value spt (for example, a vehicle speed at which the fuel consumption rate is lowest).

### Inter-vehicle Distance Keeping Processing

When the ECU 10 determines that there is a preceding vehicle V1, the ECU 10 calculates an inter-vehicle distance D between the preceding vehicle VI and the own vehicle, and the vehicle speed sp1 of the preceding vehicle V1 based on the information acquired from the camera 21 and the millimeter wave radar 22. The ECU 10 calculates a target distance Dt for the inter-vehicle distance D based on the vehicle speed sp0 of the own vehicle and the vehicle speed sp1 of the preceding vehicle V1.

When the vehicle speed sp1 of the preceding vehicle V1 with respect to the vehicle speed sp0 of the own vehicle (relative speed vr=sp1−sp0) is greater than “0”, the inter-vehicle distance D increases. In a state where the inter-vehicle distance D is larger than the target distance Dt, the ECU 10 sets the target value of the acceleration a of the own vehicle to a predetermined value α1 (>0) such that the vehicle speed sp0 of the own vehicle is greater than the vehicle speed sp1 of the preceding vehicle V1. Then, the ECU 10 controls the drive device, etc. such that the acceleration α (actual measurement value) of the own vehicle coincides with the predetermined value α1 (acceleration control). As a result, the inter-vehicle distance D decreases, and approaches to the target distance Dt. Then, when the inter-vehicle distance D coincides with the target distance Dt, the ECU 10 sets the target value of the acceleration a of the own vehicle to “0”. In other words, the ECU 10 controls the drive device, etc. such that the own vehicle travels at the same vehicle speed as the preceding vehicle V1.

On the other hand, when the relative speed vr is less than “0”, the inter-vehicle distance D is reduced. In a state where the inter-vehicle distance D is reduced to be shorter than the target distance Dt, the ECU 10 sets the target value of the acceleration α to a predetermined value α2 (<0) such that the vehicle speed sp0 of the own vehicle is lower than the vehicle speed sp1 of the preceding vehicle V1. Then, the ECU 10 controls the drive device, etc. such that the acceleration α (actual measured value) of the own vehicle coincides with the predetermined value α2 (<0) (deceleration control). As a result, the inter-vehicle distance D increases, and approaches to the target distance Dt. Then, when the inter-vehicle distance D coincides with the target distance Dt, the ECU 10 sets the target value of the acceleration a of the own vehicle to “0”.

Note that a map showing the relation between the vehicle speeds sp0, sp1 and the target distance Dt or parameters defining a formula for calculating the target distance Dt are stored in the ROM 10b. The ECU 10 determines the target distance Dt based on the map or the formula.

### Lane Keeping Processing

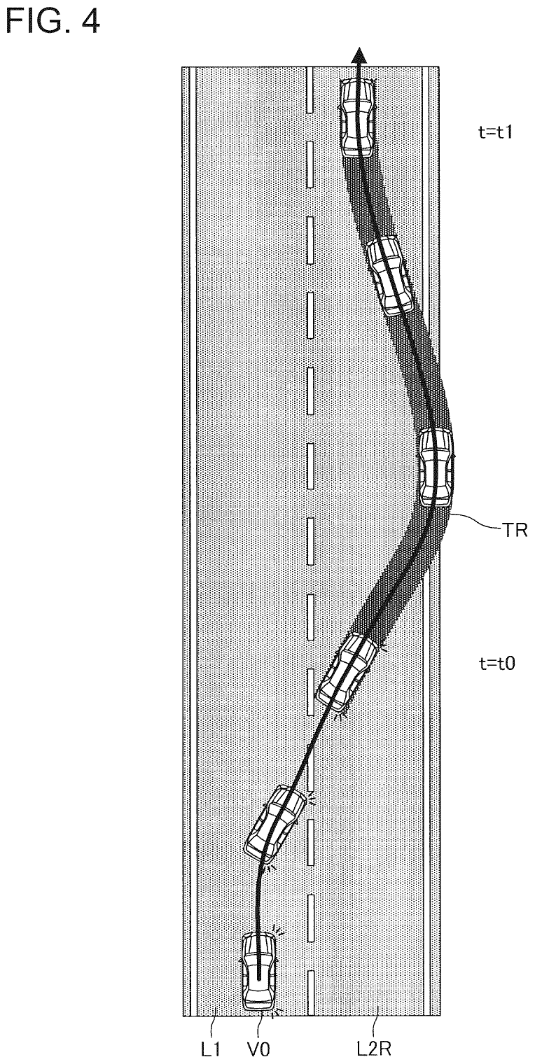

When the ACC switch is in the ON state and the LTA switch is in the ON state, the ECU 10 executes the lane keeping processing (LTA processing) for controlling the steering device 50 such that the own vehicle travels along a lane L1 (a lane in which the own vehicle is currently traveling). Specifically, based on information acquired from the camera 21, the ECU 10 controls the steering device 50 such that the own vehicle is set to be located within a predetermined range near the center portion in the width direction of the lane L1 (for example, in a state where the difference Δd (=|ΔdL−ΔdR |) between the distance ΔdL between a left-side lane marker and a predetermined point on the left side surface of the own vehicle and the distance ΔdR between a right-side lane marker and a predetermined point on the right side surface of the own vehicle is equal to or less than a threshold value Δdth) and the direction of the own vehicle is approximately parallel to the extension direction of the lane L1 (ϕ<ϕth). Here, the ECU 10 controls the steering device 50 (sets the target value θt of the steering angle θ) such that the lateral acceleration of the own vehicle when the own vehicle turns due to the execution of the LTA processing is equal to or less than a predetermined upper limit value. Specifically, the ECU 10 has a map M that defines the relation between the vehicle speed sp0 and the upper limit value θtmax of the target value θt, and refers to the map M to acquire the upper limit value θtmax corresponding to the current vehicle speed sp0. Here, the map M is designed such that the upper limit value θtmax is smaller as the vehicle speed sp0 is higher. In other words, when the vehicle speed sp0 is relatively high, the turning radius of the own vehicle cannot be made very small. Therefore, during a process of correcting the position and the attitude of the own vehicle with respect to the lane by executing the LTA processing, the own vehicle may depart from the lane (see FIG. 4). Furthermore, even in a case where the vehicle speed sp0 is relatively slow, when the attitude of the own vehicle with respect to the lane is significantly distorted (when the angle ϕ is excessively large), the own vehicle may depart from the lane during the process of correcting the position and the attitude of the own vehicle with respect to the lane by executing the LTA processing.

When the ECU 10 detects that the own vehicle has departed from the lane L1 (has fallen into a state where a part of the own vehicle overlaps the lane mark in plan view) based on information acquired from the camera 21 and the navigation system 23, the ECU 10 terminates the execution of the lane keeping processing and sets the LTA switch to the OFF state. Note that in this case, in addition to the LTA processing, the ECU 10 may terminate the execution of the ACC processing and set the ACC switch to the OFF state. Next, the ECU 10 causes the notification device 60 to display a predetermined image and play a predetermined sound in order to prompt the driver to manually perform a driving operation of moving the own vehicle to the vicinity of the center portion in the width direction of the lane. Note that the driver assistance device 1 may also have a lane deviation restraining function of controlling the steering device 50 such that the own vehicle is pulled back to the center portion side in the width direction of the lane by allowing the lateral acceleration of the own vehicle to increase slightly when the driver assistance device 1 detects that the own vehicle will depart from the lane with high possibility.

Meanwhile, the ECU 10 monitors the ON/OFF states of the first switch and the second switch of the direction indicator 70 during execution of the LTA processing. When the ECU 10 detects that the first switch or the second switch of the direction indicator 70 has transitioned from the OFF state to the ON state (the left or right turn signal lamp has started to operate (blink)), the ECU 10 temporarily stops (restricts) the execution of the ACC processing and the LTA processing. Note that in this state, the ACC switch and the LTA switch are kept in the ON state, and the ECU 10 can resume the ACC processing and the LTA processing when a condition described later is satisfied. In this state, the drive device 30, the braking device 40, the steering device 50, etc. of the own vehicle are controlled according to a driver's driving operation. For example, a driving operation (lane change) for shifting the own vehicle from the lane L1 to a lane L2R which is an adjacent lane on the right side of the lane L1, or to a lane L2L which is an adjacent lane on the left side of lane L1 can be performed as intended by the driver without intervention from the driver assistance device 1.

The ECU 10 sequentially determines whether the lane change from the lane L1 to the lane L2R (L2L) has been completed from a time point when the ECU 10 detects that the right (left) turn signal lamp has started to operate and temporarily stops the execution of the ACC processing and the LTA processing. When it is detected based on the information acquired from the camera 21 that all wheels of the own vehicle have entered the lane L2R (L2L), the ECU 10 determines that the lane change has been completed.

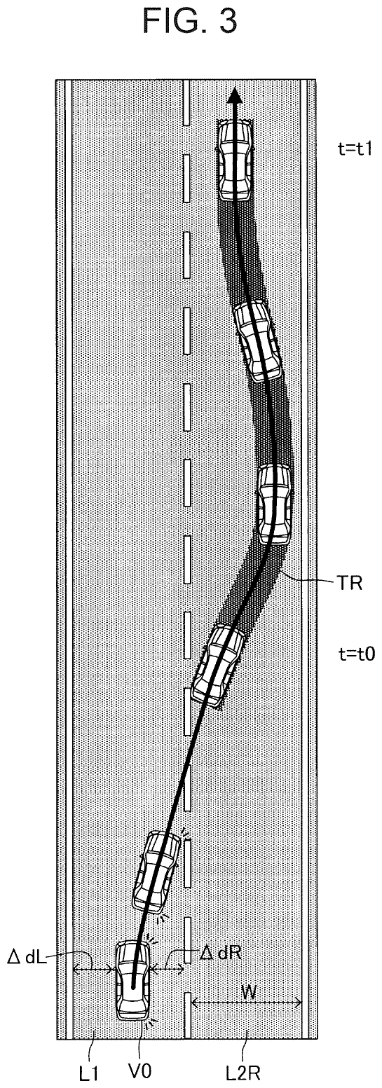

Next, the ECU 10 recognizes the shape (the curvature of the curve) of the lane L2R (L2L), and the position (lateral position) and the attitude of the own vehicle with respect to the lane L2R (L2L) based on information acquired from the camera 21 and the navigation system 23. Next, assuming that the ACC processing and the LTA processing are started (restarted) from the current time (time t0), the ECU 10 calculates an area (predicted trajectory TR) through which the own vehicle is predicted to have passed by a time t1 when the own vehicle is set to be positioned within a predetermined range in the lateral direction of the lane L2R (L2L) (Δd<Δdth) and the direction of the own vehicle is approximately parallel to the extension direction of the lane L2R (L2L) (ϕ<ϕth) (sec FIGS. 3 and 4). Here, the ECU 10 acquires the vehicle speed sp0 at time t0 (hereinafter referred to as “vehicle speed sp0−a”). When calculating the predicted trajectory TR, the ECU 10 assumes that the own vehicle travels at a vehicle speed sp0−a (travels at a constant speed) during a period T from time t0 to time t1. The ECU 10 also refers to the map M to obtain an upper limit value θtmax (hereinafter referred to as an “upper limit value θtmax−a”) corresponding to the vehicle speed sp0−a. The ECU 10 obtains, as a predicted trajectory TR, a shortest trajectory out of trajectories of the own vehicle that satisfy a condition that “during the period of time T, the own vehicle runs at a constant vehicle speed sp0−a, and the steering angle θ is equal to or less than the upper limit value θtmax−a.”

As shown in FIG. 3, when the predicted trajectory TR falls within the lane L2R (lane L2L) (when it does not deviate from the lane L2R (lane L2L)), the ECU 10 determines that a condition (release condition) for starting the ACC processing and the lane keeping processing is satisfied at time t0, and starts (resumes) these processing. In addition, the ECU 10 stops (turns off) the operation of the turn signal lamp. The operation of the turn signal lamp is automatically stopped, which causes the driver to recognize that the ACC processing and the LTA processing have been resumed. In other words, the driver can recognize that the driving operation falls into a state where the driving operation can be entrusted to the driver assistance device 1 to a certain extent. On the other hand, as shown in FIG. 4, when the predicted trajectory TR has deviated from the lane L2R (lane L2L), the

ECU 10 does not start (resume) the ACC processing and the lane keeping processing. In this case, the ECU 10 does not stop the operation of the turn signal lamp. Since the operation of the turn signal lamp has not been automatically stopped, the driver can recognize that the ACC processing and the LTA processing have not yet resumed. In other words, the driver can recognize that he or she falls into a state where they must take the initiative in performing the driving operation.

As described above, the driver assistance device 1 has a function (suspending function) of temporarily disabling the ACC function and the LTA function with initiation of the lane change from the lane L1 to the lane L2R (L2L) as a trigger, and a function (resume function) of re-enabling the ACC function and the LTA function when the lane change has been completed and the own vehicle is allowed to travel along the lane L2R (L2L). A program PR1 to be executed by the CPU 10a (hereinafter simply referred to as “CPU”) of the ECU 10 in order to implement these functions (the suspending function and the resume function) will be described below with reference to FIG. 4.

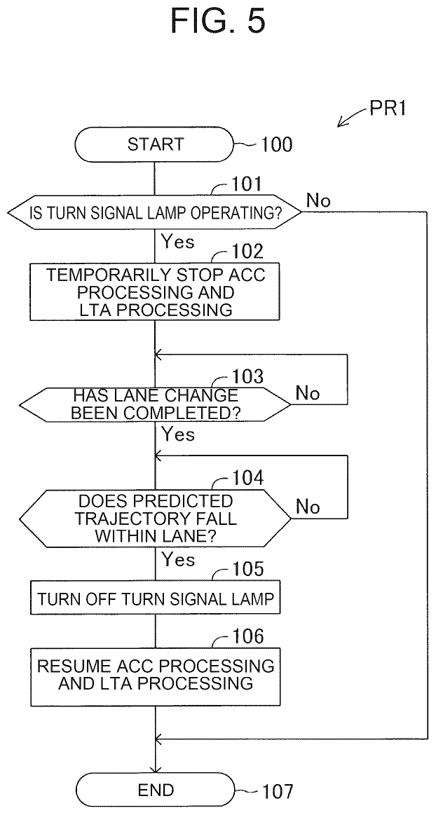

During execution of the ACC processing and the LTA processing (when the ACC switch and the LTA switch are in the ON state), the CPU executes the program PR1 shown in FIG. 5 at a predetermined cycle. The CPU starts execution of the program PR1 from step 100 and advances the processing to step 101.

In step 101, the CPU determines whether the right (left) turn signal lamp is activated (blinking). When the CPU determines that the right (left) turn signal lamp is activated (101: Yes), the CPU advances the processing to step 102. On the other hand, when the CPU does not determine that the right (left) turn signal lamp is activated (101: No), the CPU advances the processing to step 107, and terminates the execution of the program PR1 in step 107.

In step 102, the CPU temporarily stops the ACC processing and the LTA processing. Then, the CPU advances the processing to step 103.

In step 103, the CPU determines whether the lane change from the lane L1 to the lane L2R (L2L) has been completed. When the CPU determines that the lane change has been completed (103: Yes), the CPU advances the processing to step 104. On the other hand, when the CPU does not determine that the lane change has been completed (103: No), the CPU returns the processing to step 103. In other words, the CPU repeatedly executes step 103 until the lane change has been completed.

In step 104, the CPU determines whether the predicted trajectory TR falls within the lane L2R (L2L) (whether the release condition for releasing the restriction on the ACC processing and the LTA processing is satisfied). When the CPU determines that the predicted trajectory TR falls within the lane L2R (L2L) (104: Yes), the CPU advances the processing to step 105. On the other hand, when the CPU does not determine that the predicted trajectory TR falls within the lane L2R (L2L) (104: No), the CPU returns the processing to step 104. In other words, the CPU repeatedly executes step 104 until the release condition is satisfied. The driver shifts the own vehicle to the vicinity of the center portion in the width direction of the lane L2R (L2L) by manual driving operation. During this process, the predicted trajectory TR is successively updated. Then, when the release condition is satisfied during that process, the CPU advances the processing to step 105.

In step 105, the CPU stops the operation of the right (left) turn signal lamp. Next, the CPU advances the processing to step 106.

In step 106, the CPU resumes the ACC processing and the LTA processing. Next, the CPU advances the processing to step 107, and terminates the execution of the program PR1 in step 107.

Note that assuming a situation in which the driver intentionally interrupts the lane change (a situation in which the turn signal lamp is manually turned off) in the course of repetitive execution of step 103 by the CPU, the CPU forcibly terminates the execution of the program PR1, and changes the ACC switch and the LTA switch to the OFF state. Furthermore, there is assumed a situation in which the own vehicle departs from the lane L2R (L2L) in the course of the repetitive execution of step 104 by the CPU. In this case, the CPU forcibly terminates the execution of the program PR1, and changes the ACC switch and the LTA switch to the OFF state. Note that when the CPU forcibly terminates the execution of program PR1, the CPU may cause the notification device 60 to display a predetermined image and play a predetermined sound.

### Effect

As in the conventional device, when the LTA processing is resumed at the time when the lane change from the lane L1 to the lane L2R (L2L) has been completed, the own vehicle may fall into a state where the own vehicle departs from the lane L2R (L2L) within a short period of time after the resumption of the LTA processing in spite of the resumption of the LTA processing, so that the LTA processing (and the ACC processing) must be interrupted. When determining that the lane change from the lane L1 to the lane L2R (L2L) has been completed, the ECU 10 of the driver assistance device 1 according to the present embodiment resumes the ACC processing and the LTA processing if the condition for determining whether it is possible to control the own vehicle such that the own vehicle travels along the lane L2R (L2L) (the release condition for releasing the restriction on the ACC processing and the LTA processing) is satisfied (when the predicted trajectory TR falls within the lane L2R (L2L)). This makes it possible to restrain the own vehicle from falling into a state where the LTA processing must be interrupted within a short period of time after the resumption of the LTA processing (a state where the own vehicle departs from the lane L2R (L2L)) even though the LTA processing has been resumed on the lane L2R (L2L). In other words, according to the driver assistance device 1, the LTA processing is resumed at an appropriate timing after the lane change has been completed. Furthermore, the operation of the turn signal lamp is automatically stopped (turned off) at the time point when the release condition is satisfied. This allows the driver to recognize that the lane keeping processing has been resumed. In other words, the driver can recognize that the own vehicle falls into a state where the driving operation (steering) can be entrusted to the driver assistance device to a certain extent.

### Modification

As described above, when the ECU 10 detects that the right (left) turn signal lamp has started to operate, it temporarily stops the execution of the ACC processing and the LTA processing. In a period of time from the above time point to a time before the lane change to the lane L2R (L2L) has been completed, the ECU 10 sequentially acquires information from the camera 21 and the millimeter wave radar 22, and sequentially determines, based on the information, whether it is difficult to execute the LTA processing on the lane L2R (L2L) (whether a cancel condition is satisfied). When the ECU 10 determines that the cancel condition is satisfied, it forcibly turns off the turn signal lamp. In other words, the driver assistance device 1 may have a function of proposing interruption of lane change to the driver. Note that the ECU 10 determines that the cancel condition is satisfied, for example, when it detects that the width W of the lane L2R (L2L) is equal to or less than a threshold value (the road width is extremely narrow) or when it detects that an obstacle (fallen object) is present in the lane L2R (L2L).

What is claimed is:

1. A driver assistance device comprising:
an on-vehicle sensor including a sensor that acquires a position and an attitude of an own vehicle with respect to a lane in which the own vehicle is traveling, and a sensor that acquires a vehicle speed of the own vehicle, and
a processor configured to execute lane keeping processing for controlling the own vehicle such that the own vehicle travels along the lane, wherein the processor is configured to restrict execution of the lane keeping processing when a turn signal lamp of the own vehicle starts to operate under a condition that the own vehicle is traveling in a first lane, and then stop the operation of the turn signal lamp and release the restriction on the execution of the lane keeping processing when it is determined that lane change to a second lane adjacent to the first lane has been completed and a predetermined release condition for determining that the own vehicle is enabled to be controlled to travel along the second lane is satisfied.

2. The driver assistance device according to claim 1, wherein the processor is configured to determine, based on information acquired from the on-vehicle sensor, that lane change from the first lane to the second lane has been completed when it is detected that all wheels of the own vehicle have entered the second lane.

3. The driver assistance device according to claim 2, wherein the processor is configured to assume that the lane keeping processing is resumed from a current time point when determining that the lane change has been completed, calculate a predicted trajectory which is an area through which the own vehicle is predicted to have passed until a predetermined condition regarding the position and the attitude of the own vehicle with respect to the second lane is satisfied by execution of the lane keeping processing, and determine that the release condition is satisfied when the predicted trajectory falls within the second lane.

4. The driver assistance device according to claim 1, wherein the processor is configured to stop an operation of the turn signal lamp when a cancel condition for determining that it is difficult to perform the lane keeping processing on the second lane is satisfied in a period of time before it is determined that lane change from the first lane to the second lane has been completed after detecting that the turn signal lamp starts to operate during traveling of the own vehicle in the first lane.

5. The driver assistance device according to claim 4, wherein the processor is configured to determine that the cancel condition is satisfied when a width of the second lane is equal to or less than a threshold value or when an obstacle is present in the second lane.
